(19) United States
(12) Patent Application Publication
(10) Pub. No.: US 2026/0211363 A1
(43) Pub. Date: Jul. 23, 2026

(54) IMAGE FORMING APPARATUS

(71) Applicant: Konica Minolta, Inc., Tokyo (JP)

(72) Inventor: Kunihiko KANOU, Aichi (JP)

(21) Appl. No.: 19/455,206

(22) Filed: Jan. 21, 2026

(30) Foreign Application Priority Data
Jan. 22, 2025 (JP) 2025-009039

(51) Int. Cl. G03G 15/00; G01N 3/06; G01N 3/20

(52) U.S. Cl. CPC G03G 15/6558; G01N 3/06; G01N 3/20; G01N 2203/0282; G03G 2215/00628; G03G 2215/00738

(57) ABSTRACT

An image forming apparatus includes: a holder that holds a recording medium being conveyed in a vertical direction; a pressing member that presses a sheet at a lower side of a holding position of the holder; a stiffness detector that detects, as stiffness of the recording medium, a reaction force from the recording medium pressed and bent by the pressing member; and a pressing mover that moves the pressing member so as to suppress misregistration between a distal end portion of the pressing member and the recording medium when the pressing member presses the recording medium.

### CROSS REFERENCE TO RELATED APPLICATIONS

The present invention claims priority under 35 U.S.C. § 119 to Japanese Patent Application No. 2025-009039 filed on Jan. 22, 2025, the entire content of which is incorporated herein by reference.

### BACKGROUND

### Technological Field

The present disclosure relates to an image forming apparatus.

### Description of Related Art

In an image forming apparatus, a technique is known in which the stiffness of a sheet that a recording medium is detected, and based on the detection result, various control parameters for performing image formation and the like on the sheet are set. Various developments have also been made on a stiffness measuring unit for measuring the stiffness of a sheet, and the applicant of the present application has also filed an application for a stiffness measuring unit, the contents of which have already been published (see Japanese Unexamined Patent Publication No. 2024-19982 Gazette). The following briefly describes a configuration of a stiffness measuring unit (referred to as a stiffness measurement apparatus in Japanese Unexamined Patent Publication No. 2024-19982) according to the related art.

The stiffness measuring unit includes a holder that holds the sheet being conveyed in the vertical direction, and a pressing member (referred to as a pressing section in Japanese Unexamined Patent Publication No. 2024-19982) that horizontally presses the sheet below the holding position of the holder. Further, the stiffness measuring unit includes a stiffness detection unit (referred to as a pressing force detector in Japanese Unexamined Patent Publication No. 2024-19982) that detects, as the stiffness of the sheet, a reaction from the sheet that is pressed and bent by the pressing member. Further, the stiffness measuring unit is provided with a pressing mover (referred to as a moving mechanism in Japanese Unexamined Patent Publication No. 2024-19982) for linearly moving the pressing member in the horizontal direction.

According to the configuration of the stiffness measuring unit according to the related art, in a state where the sheet being conveyed in the vertical direction is held by the holder, the pressing member is linearly moved in the horizontal direction to press the sheet, and thus the stiffness of the sheet can be detected. Thus, in the detection of the stiffness of the sheet, the influence of the gravity acting on the sheet can be suppressed, and the detection accuracy of the stiffness measuring unit can be enhanced.

### SUMMARY

Incidentally, in the stiffness measuring unit according to the related art, the pressing member presses the sheet while linearly moving in the horizontal direction, whereas the sheet is pressed and bent in a circular arc shape with the holding position of the holder as a center. Therefore, when the pressing member presses the sheet, a displacement (misregistration) of the distal end portion of the pressing member with respect to the sheet occurs, and correspondingly, a catching force (friction force) of the pressing member on the sheet is generated as noise in the detection of the stiffness of the sheet. Therefore, in the stiffness measuring unit according to the related art, further improvement is desired in order to further enhance detection accuracy in detection of the stiffness of the sheet.

Therefore, objectives of the present invention include providing an image forming apparatus capable of further enhancing detection accuracy of the stiffness of a recording medium such as a sheet.

In order to achieve at least one of the above-described objectives, an image forming apparatus reflecting one aspect of the present invention includes:
a holder that holds a recording medium being conveyed in a vertical direction;
a pressing member that presses a sheet at a lower side of a holding position of the holder;
a stiffness detector that detects, as stiffness of the recording medium, a reaction force from the recording medium pressed and bent by the pressing member; and
a pressing mover that moves the pressing member so as to suppress displacement of a distal end portion of the pressing member with respect to the recording medium when the pressing member presses the recording medium.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an image forming system according to the present embodiment;

FIG. 2 is a schematic plan view of a stiffness measuring unit according to the present embodiment;

FIG. 3 is an enlarged view taken along line I-I in FIG. 2 and illustrates a state before a pressing member presses a sheet;

FIG. 4 is an enlarged view taken along line I-I in FIG. 2 and illustrates a state after the pressing member presses the sheet;

FIG. 5 is a schematic plan view of a stiffness measuring unit according to another aspect of the present embodiment;

FIG. 6 is an enlarged view taken along line II-II in FIG. 5 and illustrates a state before a pressing member presses a sheet;

FIG. 7 is an enlarged view taken along line II-II in FIG. 5 and illustrates a state after the pressing member presses the sheet;

FIG. 8 is a schematic plan view of a stiffness measuring unit according to another aspect of the present embodiment;

FIG. 9 is an enlarged view taken along line III-III in FIG. 8 and illustrates a state before a pressing member presses a sheet;

FIG. 10 is an enlarged view taken along line III-III in FIG. 8, illustrating a state after the pressing member presses the sheet; and

FIG. 11 is a control block diagram of the image forming system according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, the present embodiment will be described with reference to the drawings. In the specification and claims of the present application, the upstream refers to an upstream in a conveyance direction of a recording medium such as a sheet, and the downstream refers to a downstream in the conveyance direction of the recording medium such as a sheet. The vertical direction is not limited to a strict vertical direction, and includes a direction inclined in a range of ±30 degrees with respect to the strict vertical direction. In the drawings, “front” indicates a front direction, “rear” indicates a rear direction, “left” indicates a left direction, “right” indicates a right direction, “up” indicates an up direction, and “down” indicates a down direction.

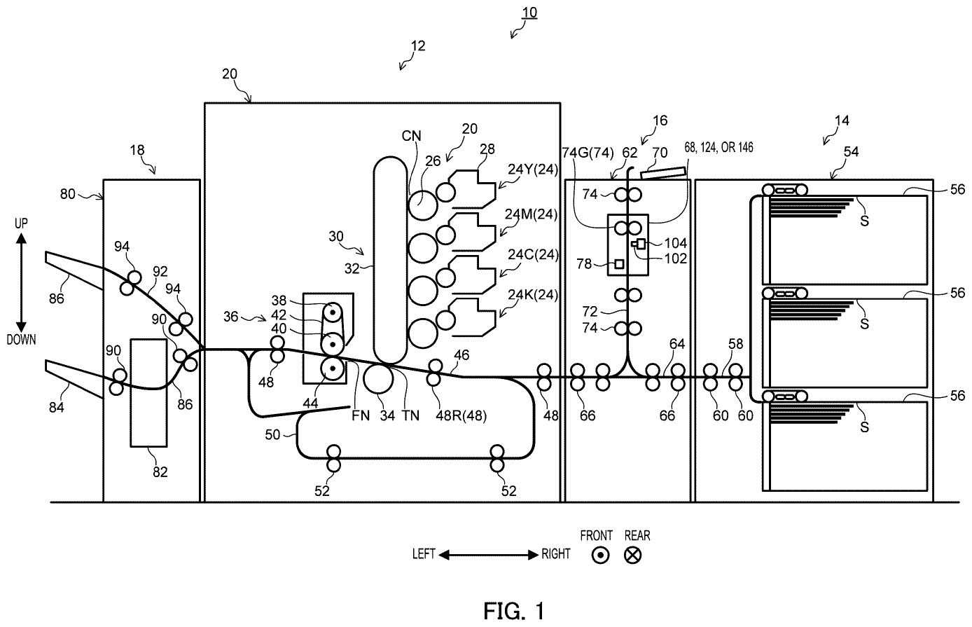

An overview of an image forming system 10 according to the present embodiment will be described with reference to FIG. 1. FIG. 1 is a schematic diagram illustrating an image forming system 10 according to the present embodiment.

As illustrated in FIG. 1, an image forming system 10 according to the present embodiment is a system that forms an image on a sheet S as an example of a recording medium and performs post-processing on the sheet S on which the image has been formed. The image forming system 10 includes a tandem-type image forming apparatus 12, and the image forming apparatus 12 is an apparatus that forms an image on a sheet S by an electrophotographic method. The image forming system 10 includes a sheet feed device 14 installed on the upstream side of the image forming apparatus 12, and the sheet feed device 14 is a device that feeds a sheet S to the image forming apparatus 12 side.

The image forming system 10 includes a sheet conveyance device (medium conveyance device) 16 installed between the image forming apparatus 12 and the sheet feed device 14, and the sheet conveyance device 16 is a device that conveys a sheet S fed from the sheet feed device 14 to the image forming apparatus 12. The image forming system 10 includes a post-processing device 18 installed on the downstream side of the image forming apparatus 12, and the post-processing device 18 is a device that performs post-processing on the sheet S on which an image has been formed.

Note that as described above, the image forming system 10 includes the image forming apparatus 12, the sheet feed device 14, the sheet conveyance device 16, and the post-processing device 18, but it may be considered that the image forming apparatus 12 includes the sheet feed device 14, the sheet conveyance device 16, and the post-processing device 18. In other words, the sheet feed device 14, the sheet conveying device 16, and the post-processing device 18 may be regarded as constituting respective parts of the image forming apparatus 12.

Subsequently, a configuration of the image forming apparatus 12 will be described with reference to FIG. 1.

As illustrated in FIG. 1, the image forming apparatus 12 includes a box-shaped apparatus body (apparatus body for an image forming apparatus) 20, and the apparatus body 20 forms a base frame of the image forming apparatus 12. Furthermore, an image forming section 22 that forms an image by an electrophotographic method is provided at an upper part inside the apparatus body 20. The image forming section 22 includes four image forming units 24Y, 24M, 24C, and 24K for forming images with toner of yellow (Y), magenta (M), cyan (C), and black (K) components, respectively. Four image forming units 24Y, 24M, 24C, and 24K are arranged along the up-down direction.

The image forming unit 24Y 24M, 24C, 24K for the Y component, the M component, the C component, and the K component have a similar configuration. For convenience of illustration and description, common constituent elements are denoted by the same reference numerals, and when they are distinguished from each other, Y, M, C, or K is added to the reference numerals. In FIG. 1, reference signs are representatively provided to the constituent elements of the image forming unit 24Y for the Y constituent elements and the reference signs of the constituent elements of the other image forming units 24M, 24C, 24K are omitted.

Each of the image forming units 24 includes a photosensitive drum 26, a charging section (not illustrated), an exposure section (not illustrated), and a developing section 28.

The photosensitive drum 26 is a negative charge type organic photoreceptor formed, for example, with an undercoated layer, a charge generation layer, and a charge transport layer, sequentially stacked on a peripheral surface of an aluminum conductive cylindrical body. The photosensitive drum 26 is rotated at a constant circumferential speed by driving of a rotary motor (not illustrated). The charging section uniformly negatively charges the outer periphery surface of photosensitive drum 26. The exposure section forms an electrostatic latent image on the outer periphery surface of the photosensitive drum 26 by emitting laser light as scanning light and scanning the outer periphery surface of the photosensitive drum 26 while exposing the outer periphery surface. The developing section 28 attaches toner of each color component to the outer periphery surface of the photosensitive drum 26 to visualize the electrostatic latent image on the outer periphery surface of the photosensitive drum 26, thereby forming a toner image.

As illustrated in FIG. 1, a transfer section 30 for transferring a toner image onto a sheet S is provided in an upper portion within the apparatus body 20. The transfer section 30 includes an endless intermediate transfer belt 32 and a secondary transfer roller 34.

The intermediate transfer belt 32 extends in an up-down direction so as to face the plurality of photosensitive drums 26 and is stretched around a plurality of support rollers (not illustrated). The intermediate transfer belt 32 circulates by rotation of the plurality of support rollers. Between the outer periphery surface of the intermediate transfer belt 32 and the outer periphery surface of each photosensitive drum 26, a primary transfer nip CN for transferring the toner image from each photosensitive drum 26 to the intermediate transfer belt 32 is formed.

The secondary transfer roller 34 is positioned on an outer peripheral surface side of the intermediate transfer belt 32. The secondary transfer roller 34 rotates in a state of nipping a sheet S in cooperation with the intermediate transfer belt 32. Between the outer periphery surface of the secondary transfer roller 34 and the outer periphery surface of the intermediate transfer belt 32, a secondary transfer nip TN is formed for transferring the toner image from the intermediate transfer belt 32 onto the sheet S.

When the intermediate transfer belt 32 passes through each of the primary transfer nips CN, the toner image on the photosensitive drum 26 is sequentially superimposed and primarily transferred onto the intermediate transfer belt 32. Thereafter, when the sheet S passes through the secondary transfer nip TN, the toner image on the intermediate transfer belt 32 is secondarily transferred to the sheet S, so that an image can be formed on the sheet S.

As illustrated in FIG. 1, a fixing section 36 for fixing the toner image onto the sheet S is provided on the exit side of the secondary transfer nip TN in the apparatus body 20. The fixing section 36 includes a heating roller 38, a fixing roller 40, an endless fixing belt 42, and a pressure roller 44.

The heating roller 38 includes a hollow cylindrical cored bar and a heating device (not illustrated), such as a halogen lamp, provided inside the cored bar. The fixing roller 40 is provided at a position facing the heating roller 38. The fixing roller 40 includes a hollow cylindrical core metal, and a surface layer provided on an outer periphery surface of the core metal and made of, for example, silicone rubber or the like. The fixing belt 42 is stretched around the heating roller 38 and the fixing roller 40. The fixing belt 42 circulates by rotation of the heating roller 38 and the fixing roller 40.

The pressure roller 44 is provided at a position facing the fixing roller 40 outside the fixing belt 42 and presses against the fixing roller 40 side with a predetermined fixing load. The pressure roller 44 includes a hollow cylindrical core metal, an elastic layer provided on an outer periphery surface of the core metal and made of, for example, silicone rubber or the like, and a surface layer provided on a surface of the elastic layer and made of, for example, a PFA tube or the like. Between the fixing roller 40 and the pressure roller 44, a fixing nip FN is formed for conveyance of a sheet S while heating and pressurizing the sheet S.

When the pressure roller 44 is rotated by driving of a motor, the fixing belt 42 is driven to circulate. As the fixing belt 42 circulates, the heating roller 38 and the fixing roller 40 rotate following the fixing belt 42. Thus, the sheet S can be conveyed while being heated and pressurized at the fixing nip FN, so that the unfixed toner image can be fixed to the sheet S.

As illustrated in FIG. 1, inside the apparatus body 20, a main conveyance path 46 is provided for conveying the sheet S sent out from the sheet conveyance device 16 toward the post-processing device 18 side. The main conveyance path 46 extends from the sheet conveyance device 16 side to the post-processing device 18 side. The main conveyance path 46 is a path for conveying the sheet S sent from the sheet conveyance device 16 toward the post-processing device 18 via the secondary transfer nip TN and the fixing nip FN. The main conveyance path 46 includes a plurality of conveyance roller pairs 48 including a registration roller pairs 48R, and a plurality of conveyance roller pairs 48 are rotated by driving of a conveyance motor (not illustrated).

Below the main conveyance path 46 in the apparatus body 20, a reverse conveyance path 50 is provided for reversing the front and back of the sheet S. The reverse conveyance path 50 is a path for conveying the sheet S when a toner image is formed on the back surface of the sheet S. An inlet end portion of the reverse conveyance path 50 is connected to the downstream side of the fixing nip FN in the main conveyance path 46. An outlet end portion of the reverse conveyance path 50 is connected to an upstream side of the registration rollers 48R in the main conveyance path 46. The reverse conveyance path 50 includes a plurality of conveyance roller pair 52, and the plurality of conveyance roller pairs 52 are rotated by driving of a conveyance motor (not illustrated).

The sheet S sent from the sheet conveyance device 16 is conveyed toward the secondary transfer nip TN side via the secondary transfer nip TN and the fixing nip FN by the main conveyance path 46. At this time, an inclination of the sheet S is corrected by the registration roller pairs 48R, and a conveyance timing of the sheet S is adjusted. Then, in the secondary transfer nip TN, the toner images on the intermediate transfer belt 32 are secondarily transferred collectively onto one side (the surface or the back surface) of the sheet S, and in the fixing nip FN, the toner images are fixed onto the sheet S. Thereafter, the sheet S on which the image has been formed is conveyed to the post-processing device 18.

Subsequently, a configuration of the sheet feed device 14 will be briefly described with reference to FIG. 1.

As illustrated in FIG. 1, as described above, the sheet feed device 14 is a device that feeds a sheet S to the image forming apparatus 12 side. In other words, the sheet feed device 14 is a device that feeds the sheet S to the sheet conveyance device 16. The sheet feed device 14 is a part of the image forming system 10, but may be regarded as a part of the image forming apparatus 12. The sheet feed device 14 further includes a box-shaped apparatus body (apparatus body for the sheet feed device) 54 installed on the left side of the apparatus body 20 for the image forming apparatus, and the apparatus body 54 forms a base frame of the sheet feed device 14.

Inside the apparatus body 54, a plurality of sheet feed trays 56 for storing a plurality of sheets S are provided, and the plurality of sheet feed trays 56 are arranged in a stepwise manner along the up-down direction. Each of the sheet feed trays 56 stores sheets S of a type set in advance according to a basis weight, a size, and the like. In addition, a sheet feed conveyance path 58 for feeding a sheet from each of the sheet feed trays 56 to the sheet conveyance device 16 is provided in the apparatus body 54. The sheet feed conveyance path 58 includes a plurality of conveyance roller pairs 60, and the plurality of conveyance roller pairs 60 are rotated by driving of a conveyance motor (not illustrated).

Subsequently, a configuration of a sheet conveyance device (media conveyance device) 16 will be described with reference to FIG. 1.

As illustrated in FIG. 1, as described above, the sheet conveyance device 16 is a device that conveys a sheet S fed from the sheet feed device 14 to the image forming apparatus 12. The sheet conveyance apparatus 16 is a part of the image forming system 10 but may be regarded as a part of the image forming apparatus 12. The sheet conveyance device 16 further includes a box-shaped apparatus body (apparatus body for sheet conveyance device) 62 provided between the apparatus body 20 for the image forming apparatus and the apparatus body 54 for the sheet feed device, and the apparatus body 62 constitutes a base frame of the sheet conveyance device 16.

In the apparatus body 62, a main conveyance path 64 is provided for conveying the sheet S fed from the sheet feed device 14 to the image forming apparatus 12. The main conveyance path 64 extends in the left-right direction from the sheet feed device 14 side to the image forming apparatus 12 side. An inlet end portion of the main conveyance path 64 is connected to an outlet end portion of the sheet feeding conveyance path 58 of the sheet feed device 14. The outlet end portion of the main conveyance path 64 is connected to the inlet end portion of the main conveyance path 46 of the image forming apparatus 12. The main conveyance path 64 includes a plurality of conveyance roller pair 66, and the plurality of conveyance roller pairs 66 are rotated by driving of a conveyance motor (not illustrated).

A stiffness measuring unit 68 for measuring the stiffness of the sheet S is provided above the main conveyance path 64 in the apparatus body 62, and the stiffness measuring unit 68 will be described in detail later. Furthermore, a sheet ejection tray 70 for ejecting the sheet S whose stiffness has been measured is provided at the top of the apparatus body 62.

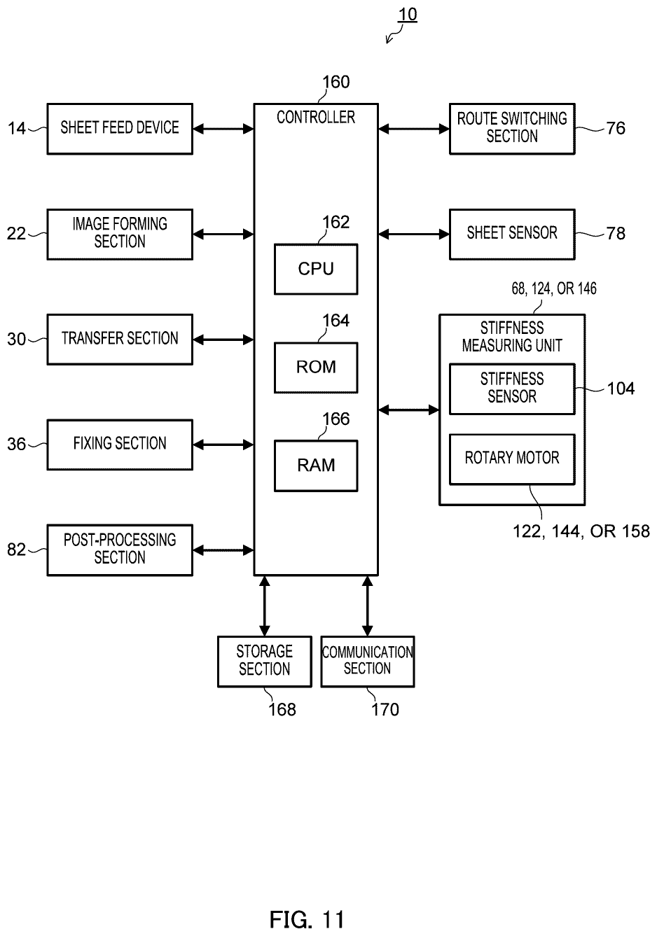

In the apparatus body 62, a vertical conveyance path 72 is provided for conveying the sheet S fed from the intermediate portion of the main conveyance path 64 to the sheet ejection tray 70 via the stiffness measuring unit 68. The vertical conveyance path 72 extends in the vertical direction from the main conveyance path 64 side to the sheet ejection tray 70 side. An inlet end portion of the vertical conveyance path 72 is connected to an intermediate portion of the main conveyance path 64, and an outlet end portion of the vertical conveyance path 72 is connected to an inlet side of the sheet ejection tray 70. The vertical conveyance path 72 includes a plurality of conveyance roller pairs 74, and the plurality of conveyance roller pairs 74 are rotated by driving of a conveyance motor (not illustrated). The plurality of conveyance roller pairs 74 include a holding roller pair 74G as a holder constituting a part of the stiffness measuring unit 68. Further, a route switching section 76 (see FIG. 11) that switches the conveyance route of the sheet S from the main conveyance path 64 to the vertical conveyance path 72 is provided at an appropriate position in the apparatus body 62.

As illustrated in FIG. 1, below the pair of holding rollers 74G in the apparatus body 62, a sheet sensor 78 as a sheet sensing section for detecting the sheet S is provided. The sheet sensor 78 is formed of, for example, a reflection-type or transmission-type photosensor, and detects the rear end in the conveyance direction of the sheet S which is being conveyed in the vertical direction by a change in the intensity of received light.

Subsequently, a configuration of the post-processing device 18 will be briefly described with reference to FIG. 1.

As illustrated in FIG. 1, as described above, the post-processing device 18 is an apparatus that performs post-processing on a sheet S on which image formation has been performed. The post-processing device 18 is a part of the image forming system 10, but may be regarded as a part of the image forming apparatus 12. The post-processing device 18 further includes a box-shaped apparatus body (apparatus body for the post-processing device) 80 installed on the left side of the apparatus body 20 for the image forming apparatus, and the apparatus body 80 forms a base frame of the post-processing device 18.

Inside the apparatus body 80, a post-processing section 82 is provided for performing post-processing, such as stapling, cutting, and perforation, on the sheet S on which image formation has been formed. On the left side part of the apparatus body 80, a sheet ejection tray 84 is provided for ejecting a post-processing sheet S. On the upper side of the sheet ejection tray 84 in the left side part of the apparatus body 80, a sheet ejection tray 86 is provided for ejecting the sheet S on which no post-processing is performed.

Inside the apparatus body 80, a sheet ejection conveyance path 88 is provided for conveying the sheet S fed from the image forming apparatus 12 to the sheet ejection tray 84 via the post-processing section 82. An inlet end portion of the sheet ejection conveyance path 88 is connected to the outlet end portion of the main conveyance path 64 of the image forming apparatus 12. An outlet end portion of the sheet ejection conveyance path 88 is connected to an inlet side of the sheet ejection tray 84 side. The sheet ejection conveyance path 88 includes a plurality of conveyance roller pairs 90, and the plurality of conveyance roller pairs 90 are rotated by driving of a conveyance motor (not illustrated).

Inside the apparatus body 80, a sheet ejection conveyance path 92 is provided for conveying the sheet S fed from the image forming apparatus 12 to the sheet ejection tray 86 without passing through the post-processing section 82. An inlet end portion of the sheet ejection conveyance path 92 is connected to the outlet end portion of the main conveyance path 64 of the image forming apparatus 12. An outlet end portion of the sheet ejection conveyance path 92 is connected to the sheet ejection tray 86 side. The sheet ejection conveyance path 92 includes a plurality of conveyance roller pairs 94, and the plurality of conveyance roller pairs 94 are rotated by driving of a conveyance motor (not illustrated).

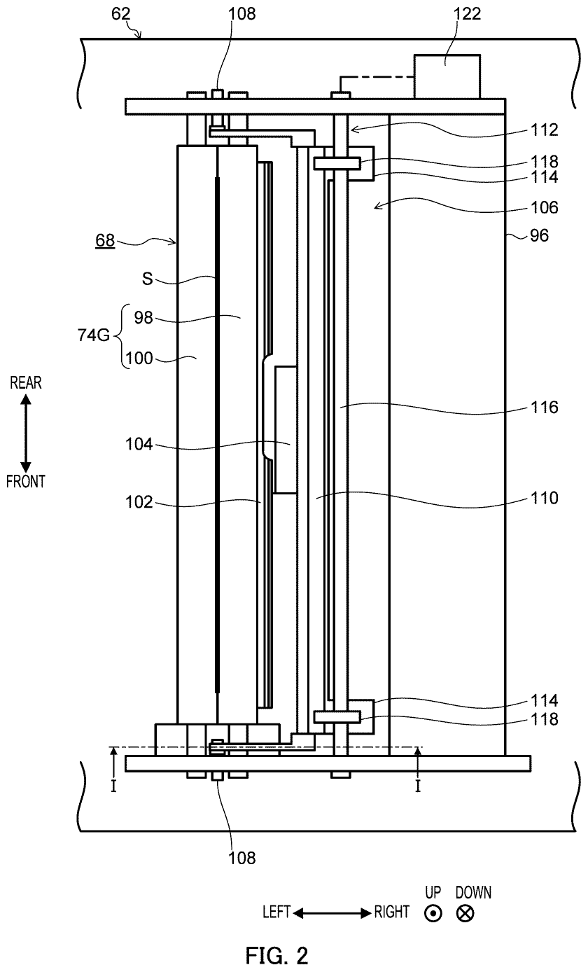

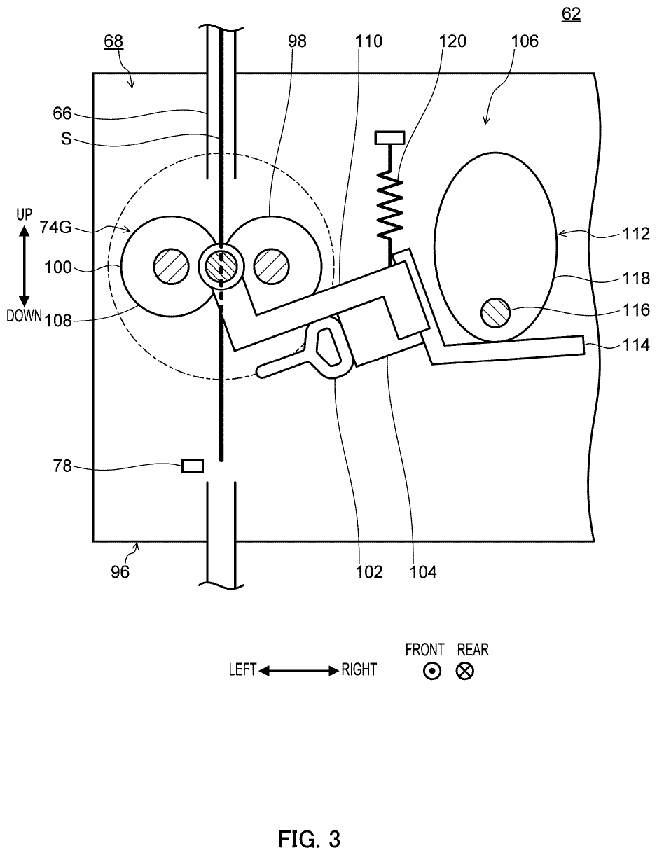

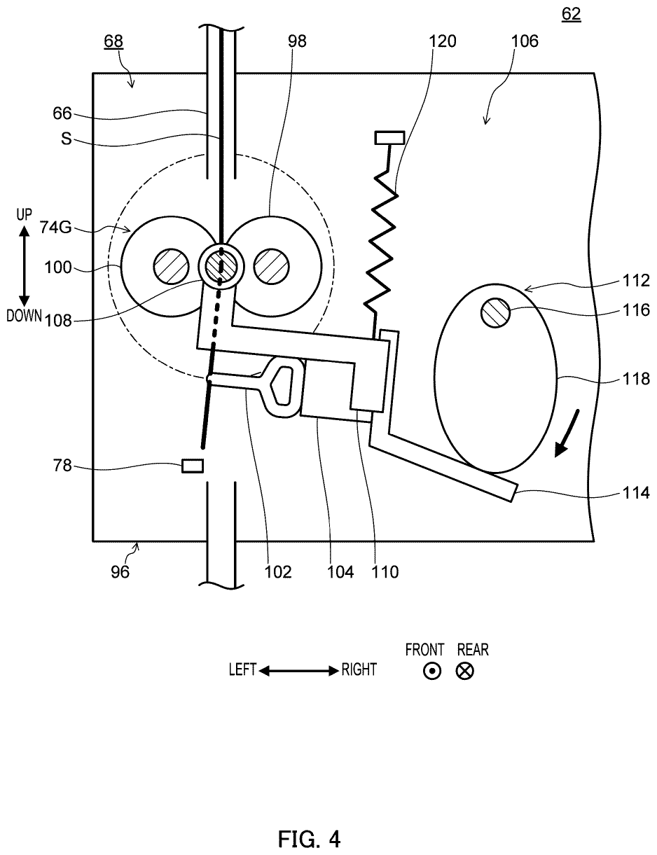

Subsequently, with reference to FIGS. 1 to 4, a specific configuration of the stiffness measuring unit 68 according to the present embodiment is described. FIG. 2 is a schematic plan view of the stiffness measuring unit 68 according to the present embodiment. FIGS. 3 and 4 are enlarged views taken along line I-I in FIG. 2, FIG. 3 shows a state before the pressing member 102 presses the sheet S, and FIG. 4 shows a state after the pressing member 102 presses the sheet S.

As illustrated in FIGS. 1 to 4, the stiffness measuring unit 68 includes a pair of holding rollers 74G as a holder that horizontally (horizontally in the left-right direction) sandwiches and holds the sheet S being vertically conveyed. The pair of holding rollers 74G is provided on a support frame 96 as a fixed portion fixed in the apparatus body 62 and extend horizontally in a front-rear direction. The holding roller pair 74G includes a drive roller 98 that is rotatably provided on the support frame 96 and rotates by driving of a conveyance motor (not illustrated). The drive roller 98 is configured to stop rotating when the sheet sensor 78 detects the rear end in the conveyance direction of the sheet S being conveyed in the vertical direction.

The holding roller pair 74G includes a driven roller 100 that is rotatably provided on the support frame 96 and rotates following the rotation of the drive roller 98. The driven roller 100 cooperates with the drive roller 98 to pinch a sheet S from horizontal left-right direction. In addition, a spring (not illustrated) that biases the driven roller 100 toward the drive roller 98 is provided at an appropriate position of the support frame 96. The holding position of the pair of holding rollers 74G refers to a position at which the sheet S is held by the pair of holding rollers 74G, and in the present embodiment, refers to a position at which the sheet S is nipped by cooperation of the drive roller 98 and the driven roller 100.

As illustrated in FIGS. 2 to 4, between the pair of holding rollers 74G and the sheet sensor 78, a pressing member 102 is provided which presses the sheet S in a horizontal left direction on a lower side (below) of the holding position of the pair of holding rollers 74G. The pressing member 102 presses the sheet S horizontally toward the left in a state where the sheet S being conveyed in the vertical direction is held by the holding roller pair 74G. The pressing member 102 extends in the horizontal front-rear direction, and the distal end portion side (left end portion side) of the pressing member 102 is formed in a plate shape. The cross-sectional shape of the distal end portion of the pressing member 102 along the vertical direction may be a curved shape (R-shape).

A stiffness sensor 104 as a stiffness detection section is provided at a base end portion of the pressing member 102, and the stiffness sensor 104 detects a reaction force from the sheet S pressed and bent by the pressing member 102 as the stiffness of the sheet S. It may be considered that the stiffness sensor 104 is coupled to the base end portion of the pressing member 102. As the stiffness sensor 104, for example, a load cell is used.

The stiffness measuring unit 68 includes a pressing mover 106 that moves the pressing member 102 so that the pressing member 102 presses and bends the sheet S. The pressing mover 106 moves the pressing member 102 such that the distal end portion of the pressing member 102 draws a circular arc centering on the holding position of the pair of holding rollers 74G when the pressing member 102 presses the sheet S. In other words, the pressing mover 106 moves the pressing member 102 so as to suppress a displacement (misregistration) of the distal end portion of the pressing member 102 with respect to the sheet S when the pressing member 102 presses the sheet S. The pressing mover 106 may move the pressing member 102 such that the distal end portion of the pressing member 102 forms a circular arc centering on the vicinity of the holding position of the pair of holding rollers 74G.

The pressing mover 106 includes an arm portion 110 that is U-shaped in plan view and is disposed at the support frame 96 so as to be swingable around axial centers of a pair of swing shafts 108, and the arm portion 110 extends in the front-rear direction. The axial center of each of the swing shafts 108 is the horizontal swing axial center of the arm portion 110 passing through the holding position of the pair of holding rollers 74G. The axial center of each swing shaft 108 may be a horizontal swing axial center that passes through the vicinity of the holding position of the pair of holding rollers 74G.

A stiffness sensor 104 is connected to a central portion of the arm portion 110. In other words, the central portion of the arm portion 110 is connected to the pressing member 102 via the stiffness sensor 104. In still other words, the pressing member 102 is disposed on the support frame 96 via the arm portion 110 and the stiffness sensor 104 so as to be swingable around the axial centers of the pair of swing shafts 108. The distances from the axial centers of the respective swing shafts 108 to the distal end portions of the pressing members 102 are the same as the distances from the holding positions of the pair of holding rollers 74G to the pressing positions of the pressing members 102. The pressing position of the pressing member 102 is a position at which the sheet S is pressed by the pressing member 102.

The pressing mover 106 includes a cam mechanism 112 for swinging the arm portion 110 about the axes of the swing shafts 108. The cam mechanism 112 has abutting pieces 114 integrally provided on both end portion sides of the arm portion 110, and each abutting piece 114 protrudes in the right direction. The cam mechanism 112 has a cam shaft 116 rotatably provided on the right side of the holding roller pair 74G in the support frame 96, and the cam shaft 116 extends in the front-rear direction.

The cam mechanism 112 includes cam plates 118 that are integrally provided on respective end portion sides of a cam shaft 116, and cam plates 118 abut on abutting pieces 114, respectively. The center of rotation of each cam plate 118 is eccentric to the axis of the cam shaft 116. The outer shape of each cam plate 118 is formed such that the distance from the contact position between the contact piece 114 and the cam plate 118 to the axial center of the cam shaft 116 is changed by the rotation of the cam shaft 116. The cam mechanism 112 has a spring 120 provided between an appropriate position of the support frame 96 and each contact piece 114. Each spring 120 biases the arm portion 110 in a reverse direction (counterclockwise direction in FIGS. 3 and 4) so as to bring each contact piece 114 into contact with each cam plate 118.

The pressing mover 106 includes a rotary motor 122 as a rotary actuator which is provided at an appropriate position of the support frame 96 and rotates each cam plate 118 integrally with the cam shaft 116. An output shaft (not illustrated) of the rotary motor 122 is interlockingly connected to the cam shaft 116 via a gear train (not illustrated) or the like. Each cam plate 118 rotates in a forward direction (a clockwise direction in FIGS. 3 and 4) and a reverse direction (a counterclockwise direction in FIGS. 3 and 4) by driving of the rotary motor 122.

According to the configuration of the stiffness measuring unit 68, when the sheet sensor 78 detects the rear end in the conveyance direction of the sheet S being conveyed in the vertical direction, the rotation of the drive roller 98 and the driven roller 100 is stopped. Thus, as illustrated in FIG. 3, the sheet S being conveyed in the vertical direction is nipped and held by the holding roller pair 74G from the horizontal direction.

Next, as illustrated in FIGS. 3 and 4, when each cam plate 118 is rotated in the forward direction by driving of the rotary motor 122, the arm portion 110 swings in the forward direction around the axial center of the swing shaft 108 against the biasing force of each spring 120. Then, the pressing member 102 moves and presses the sheet S such that the distal end portion of the pressing member 102 draws a circular arc centering on the holding position of the holding roller pair 74G. At this time, the stiffness sensor 104 detects, as the stiffness of the sheet S, a reaction force from the sheet S pressed and bent by the pressing member 102.

After the stiffness of the sheet S is detected, each cam plate 118 is rotated in the reverse direction by the driving of the rotary motor 122, so that the arm portion 110 and the pressing member 102 return to their original positions. Furthermore, the rotation of the drive roller 98 and the driven roller 100 is resumed, and the sheet S whose stiffness has been detected is conveyed in the vertical direction.

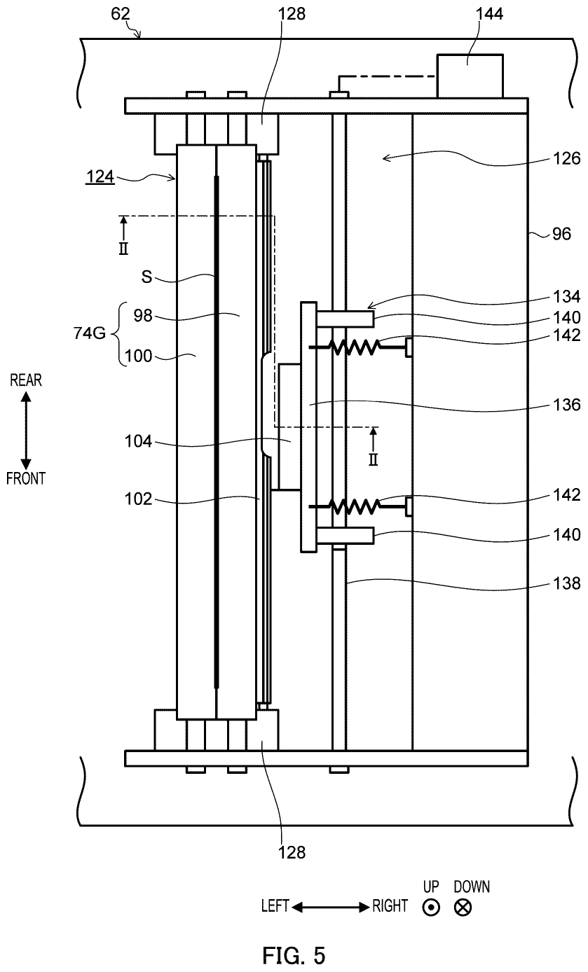

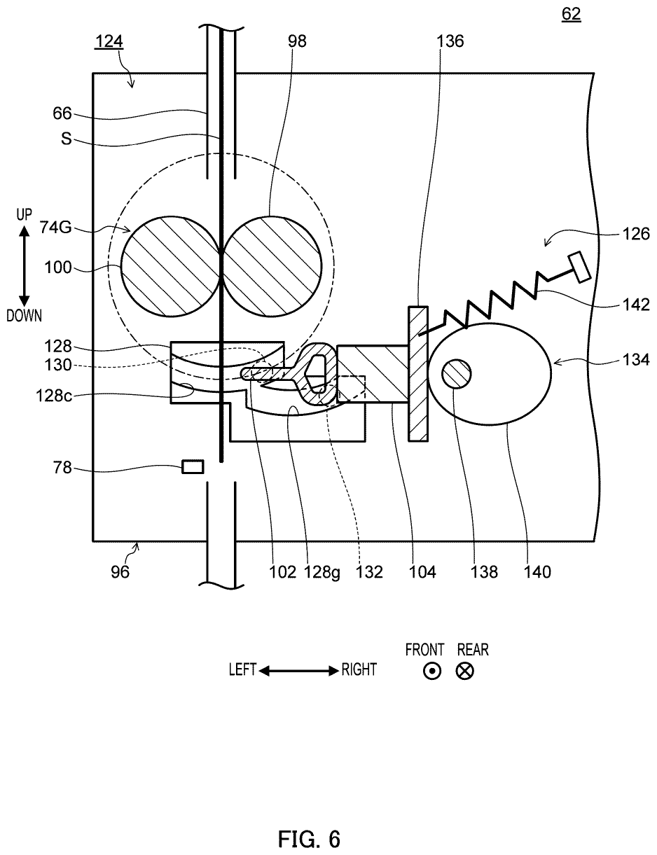

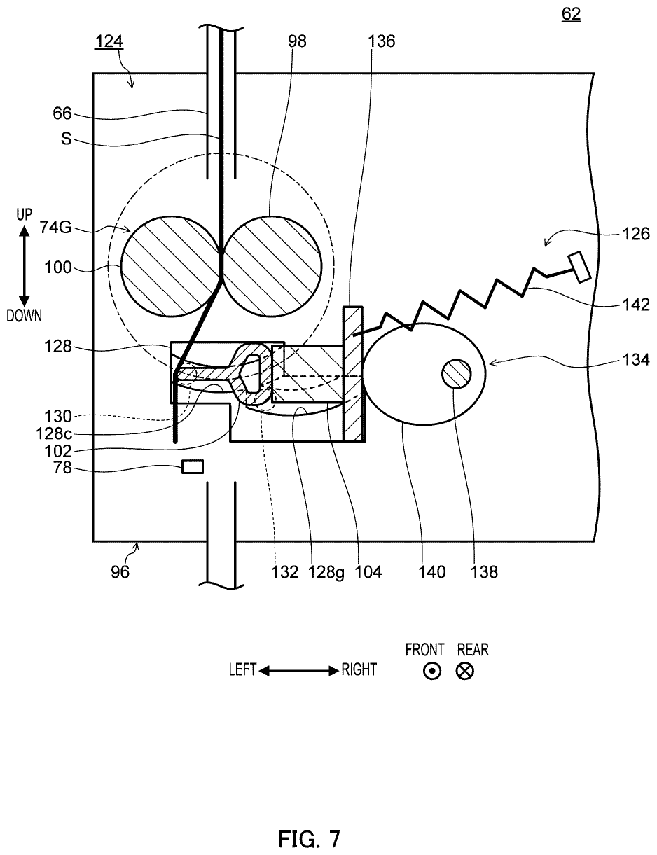

Subsequently, a configuration of the stiffness measuring unit 124 according to another aspect of the present embodiment will be described with reference to FIG. 1 and FIGS. 5 to 7. FIG. 5 is a schematic plan view of a stiffness measuring unit 124 according to another aspect of the present embodiment. FIG. 6 and FIG. 7 are enlarged views taken along line II-II in FIG. 5, FIG. 6 shows a state before the pressing member 102 presses the sheet S, and FIG. 7 shows a state after the pressing member 102 presses the sheet S.

As illustrated in FIG. 1, the sheet conveyance apparatus 16 may include a stiffness measuring unit 124 according to another aspect of the present embodiment in place of the stiffness measuring unit 68 according to the present embodiment. The stiffness measuring unit 124 according to another aspect of the present embodiment has the same configuration as the stiffness measuring unit 68 according to the present embodiment. Among the configurations of the stiffness measuring unit 124 according to another aspect of the present embodiment, differences from the configuration of the stiffness measuring unit 68 according to the present embodiment will be described. Note that for convenience of explanation, members having the same function as the members described in the stiffness measuring unit 68 according to the present embodiment are denoted by the same reference signs, and the description thereof is not repeated.

As illustrated in FIGS. 5 to 7, the stiffness measuring unit 124 includes a pressing mover 126 that moves the pressing member 102 so that the pressing member 102 presses and bends the sheet S. The pressing mover 126 moves the pressing member 102 such that the distal end portion of the pressing member 102 forms a circular arc centering on the holding position of the pair of holding rollers 74G while maintaining the posture of the pressing member 102 when the pressing member 102 presses the sheet S. In other words, the pressing mover 126 moves the pressing member 102 so as to suppress a displacement (misregistration) of the distal end portion of the pressing member 102 with respect to the sheet S when the pressing member 102 presses the sheet S. The pressing mover 126 may move the pressing member 102 such that the distal end portion of the pressing member 102 forms a circular arc centering on the vicinity of the holding position of the pair of holding rollers 74G.

The pressing mover 126 includes a guide member 128 provided on the lower side of each end portion of the pair of holding rollers 74G in the support frame as the fixed portion. Guide members 128 guide respective lateral end portions of the pressing member 102 so as to maintain the posture of the pressing member 102. An arc-shaped first guide groove 128c is formed in each of the guide members 128. The first guide groove 128c of each of the guide members 128 slidably guides a first slider 130 provided at a portion on the distal end portion side in the lateral end portion of the pressing member 102. In other words, the first guide groove 128c of each guide member 128 slidably guides the portion on the distal end portion side in the lateral end portion of the pressing member 102 via the first slider 130.

An arc-shaped second guide groove 128g is formed in each of the guide members 128 at a position shifted obliquely downward to the right with respect to the first guide groove 128c. The second guide groove 128g of each guide member 128 slidably guides a second slider 132 provided at a portion on the base end portion side in the lateral end portion of the pressing member 102. In other words, the second guide groove 128g of each guide member 128 slidably guides a portion on the base end portion side in the lateral end portion of the pressing member 102 via the second slider 132.

Here, the radius and center of curvatures of the first guide groove 128c, the radius and center of curvatures of the second guide groove 128g, and the like are set such that the distal end portion of the pressing member 102 forms a circular arc centering on the holding position of the pair of holding rollers 74G or the vicinity thereof.

The pressing mover 126 includes a cam mechanism 134 for moving the pressing member 102 in a state where the lateral end portions of the pressing member 102 are guided respectively by the guide members 128. The cam mechanism 134 has a contact plate 136 integrally connected to the stiffness sensor 104, and the contact plate 136 extends in the front-rear direction. The cam mechanism 134 has a cam shaft 138 rotatably provided on the right side of the holding roller pair 74G in the support frame 96, and the cam shaft 138 extends in the front-rear direction.

The cam mechanism 134 includes a pair of cam plates 140 integrally provided on a middle side of the cam shaft 138, and the pair of cam plates 140 are spaced from each other in the front-rear direction. Each cam plate 140 is in contact with the contact plate 136, and the center of each cam plate 140 is eccentric to the axis of the cam shaft 138. The outer shape of each cam plate 140 is formed such that the distance from the contact position between the contact plate 136 and the cam plate 140 to the axial center of the cam shaft 138 is changed by the rotation of the cam shaft 138. Further, the cam mechanism 134 has a pair of springs 142 which are provided between appropriate positions of the support frame 96 and the contact plate 136 and which bias the contact plate 136 in a direction in which it comes into contact with the pair of cam plates 140.

The pressing mover 126 includes a rotary motor 144 as a rotary actuator which is provided at an appropriate position of the support frame 96 and rotates each cam plate 140 integrally with the cam shaft 138. An output shaft (not illustrated) of the rotary motor 144 is interlockingly connected to the cam shaft 138 via a gear train (not illustrated) or the like. Each cam plate 140 rotates in a forward direction (a clockwise direction in FIGS. 6 and 7) and a reverse direction (a counterclockwise direction in FIGS. 6 and 7) by driving of the rotary motor 144.

According to the configuration of the stiffness measuring unit 124, when the sheet sensor 78 detects the rear end in the conveyance direction of the sheet S being conveyed in the vertical direction, the rotation of the drive roller 98 and the driven roller 100 is stopped. Thus, as illustrated in FIG. 6, the sheet S being conveyed in the vertical direction is nipped and held by the holding roller pair 74G from the horizontal direction.

Next, as illustrated in FIGS. 6 and 7, each cam plate 140 is rotated in the forward direction by driving of the rotary motor 144. Then, in a state where the posture of the pressing member 102 is maintained, the pressing member 102 moves and presses the sheet S such that the distal end portion of the pressing member 102 forms a circular arc centering on the holding position of the pair of holding rollers 74G or the vicinity thereof. At this time, the stiffness sensor 104 detects, as the stiffness of the sheet S, a reaction force from the sheet S pressed and bent by the pressing member 102.

After the detection of the stiffness of the sheet S, each cam plate 140 is rotated in the reverse direction by the driving of the rotary motor 144, so that the pressing member 102 returns to the original position. Furthermore, the rotation of the drive roller 98 and the driven roller 100 is resumed, and the sheet S whose stiffness has been detected is conveyed in the vertical direction.

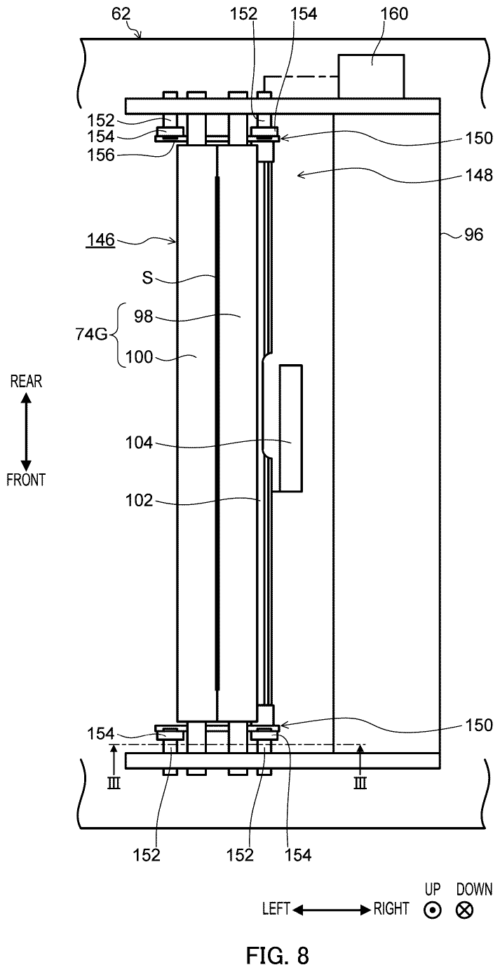

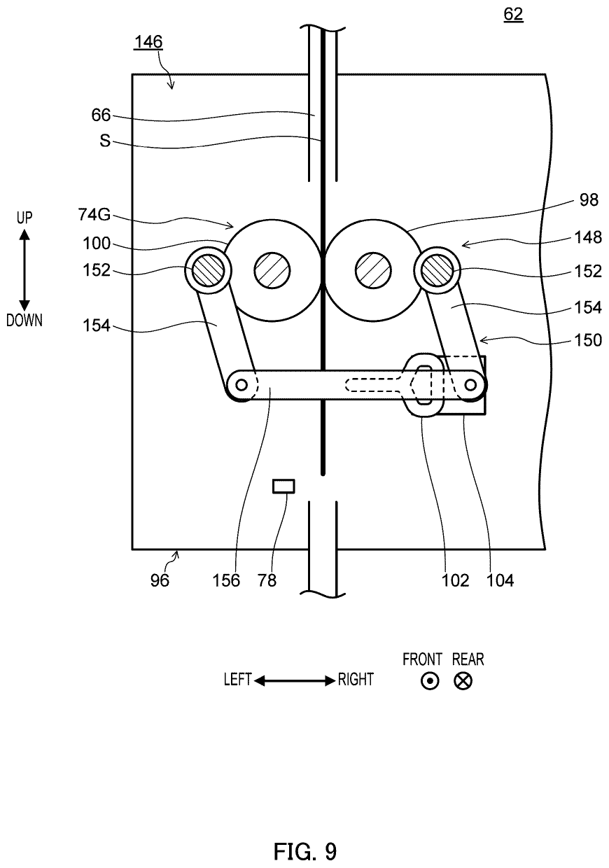

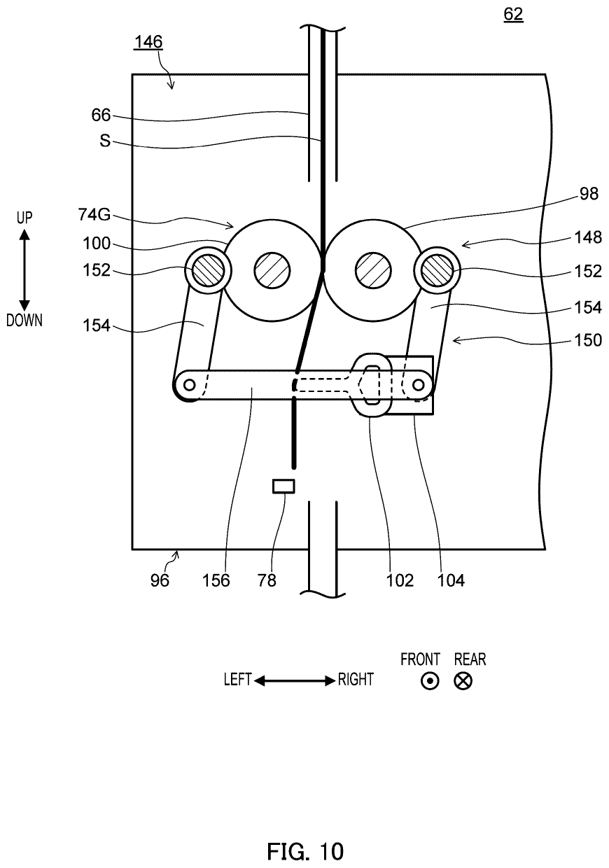

Subsequently, a configuration of the stiffness measuring unit 146 according to another aspect of the present embodiment will be described with reference to FIG. 1 and FIGS. 8 to 10. FIG. 8 is a schematic plan view of a stiffness measuring unit 146 according to another aspect of the present embodiment. FIG. 9 and FIG. 10 are enlarged views taken along line III-III in FIG. 8, FIG. 9 shows a state before the pressing member 102 presses the sheet S, and FIG. 10 shows a state after the pressing member 102 presses the sheet S.

As illustrated in FIG. 1, the sheet conveyance apparatus 16 may include a stiffness measuring unit 146 according to another aspect of the present embodiment in place of the stiffness measuring unit 68 according to the present embodiment. The stiffness measuring unit 146 according to another aspect of the present embodiment has the same configuration as the stiffness measuring unit 68 according to the present embodiment. Among the configurations of the stiffness measuring unit 146 according to another aspect of the present embodiment, differences from the configuration of the stiffness measuring unit 68 according to the present embodiment will be described. Note that for convenience of explanation, members having the same function as the members described in the stiffness measuring unit 68 according to the present embodiment are denoted by the same reference signs, and the description thereof is not repeated.

As illustrated in FIGS. 8 to 10, the stiffness measuring unit 146 includes a pressing mover 148 that moves the pressing member 102 so that the pressing member 102 presses and bends the sheet S. The pressing mover 148 moves the pressing member 102 in a state where the posture of the pressing member 102 when the pressing member 102 presses the sheet S is maintained. In other words, the pressing mover 148 moves the pressing member 102 so as to suppress misregistration with respect to the sheet S between the distal end portion of the pressing member 102 and the sheet S when the pressing member 102 presses the sheet S.

The pressing mover 148 includes parallel link mechanisms 150 that are disposed on both lateral end portion sides of the pair of holding rollers 74G in the support frame 96 as the fixed portion, respectively, and that are for translating the pressing member 102 in the horizontal direction. Each of the parallel link mechanisms 150 includes a pair of swing links 154 swingably provided on a lateral end portion side of a pair of holding rollers 74G in the support frame 96 via swing shafts 152, and the pair of swing links 154 swing in a state of being kept in parallel with each other. Each swing shaft 152 in each parallel link mechanism 150 is rotatably supported by the support frame 96 and is integrally connected to a base end portion of each swing link 154.

Each of the parallel link mechanisms 150 has a translational movement link 156 that connects the distal end portions of the pair of swing links 154 to each other, and the translational movement link 156 is capable of translational movement in the horizontal direction (horizontal left-right direction). The translational movement link 156 in each parallel link mechanism 150 is connected to each lateral end portion of the pressing member 102. In other words, the pressing member 102 is provided on the support frame 96 via the pair of parallel link mechanisms 150. The pressing member 102 is disposed between the pair of parallel link mechanisms 150.

The pressing mover 148 includes a rotary motor 158 as a rotary actuator that is provided at an appropriate position in the support frame 96 and rotates a predetermined swing shaft 152. An output shaft (not illustrated) of the rotary motor 158 is interlockingly connected to a predetermined swing shaft 152 via a gear train (not illustrated) or the like. The predetermined swinging shaft 152 rotates in a forward direction (a clockwise direction in FIGS. 9 and 10) and a reverse direction (a counterclockwise direction in FIG. 9 and FIG. 10) by driving the rotary motor 158.

According to the configuration of the stiffness measuring unit 146, when the sheet sensor 78 detects the rear end in the conveyance direction of the sheet S being conveyed in the vertical direction, the rotation of the drive roller 98 and the driven roller 100 is stopped. Thus, as illustrated in FIG. 9, the sheet S being conveyed in the vertical direction is nipped and held by the holding roller pair 74G from the horizontal direction.

As shown in FIG. 9 and FIG. 10, when the predetermined swing shaft 152 is rotated in the forward direction by the driving of the rotary motor 158, each of the translational movement links 156 moves in the horizontal left direction while each of the pair of swing links 154 swings in the forward direction. Then, in a state where the posture of the pressing member 102 is maintained, the pressing member 102 moves translationally in the horizontal direction and presses the sheet S in the horizontal direction. At this time, the stiffness sensor 104 detects, as the stiffness of the sheet S, a reaction force from the sheet S pressed and bent by the pressing member 102.

After the detection of the stiffness of the sheet S, the predetermined swing shaft 152 is rotated in the reverse direction by the driving of the rotary motor 158, whereby each translational movement link 156 moves in the horizontal right direction while each pair of swing links 154 swings in the reverse direction, and the pressing member 102 returns to the original position. Furthermore, the rotation of the drive roller 98 and the driven roller 100 is resumed, and the sheet S whose stiffness has been detected is conveyed in the vertical direction.

With reference to FIG. 1 and FIG. 11, a description is given of a control configuration of the image forming system 10 according to the present embodiment. FIG. 11 is a control block diagram of the image forming system 10 according to the present embodiment.

As shown in FIG. 11, the image forming system 10 includes a controller 160 that controls the sheet feed device 14, the image forming section 22, the transfer section 30, the fixing section 36, the route switching section 76, the stiffness measuring unit 68, 124, or 146, the post-processing section 82, and the like. The controller 160 plays a role in managing control of the entire image forming system 10. The controller 160 includes a Central Processing Unit (CPU) 162, a Read Only Memory (ROM) 164, and a Random Access Memory (RAM) 166. The storage section 168, the communication section 170, the paper sensor 78, and the like are connected to the controller 160.

The CPU 162 comprehensively controls the entire operation of the image forming system 10. The CPU 162 reads various control programs and setting data stored in the ROM 164, stores the load programs and data in the RAM 166, and executes the programs to carry out various calculation processes. The RAM 166 provides a working memory space for the CPU 162 and stores temporary data. In addition, the CPU 162 refers to various kinds of data stored in the storage section 168 in a case of performing various kinds of arithmetic processing. The storage section 168 is configured by, for example, a nonvolatile semiconductor memory or a hard disk drive.

The controller 160 transmits/receives various types of data to/from an external device (e.g., a computer) connected to a network such as a Local Area Network (LAN), a Wide Area Network (WAN) via the communication section 170. For example, the controller 160 receives a print job transmitted from an external device and controls to form a toner image on the sheet S on the basis of image data included in the print job. The communication section 170 is constituted by a communication control card such as a LAN card.

As illustrated in FIGS. 1 and 11, upon receiving an instruction to measure the stiffness of the sheet S, the controller 160 controls the route switching section 76 so as to switch the conveyance route of the sheet S from the main conveyance path 64 to the vertical conveyance path 72. When the controller 160 switches the conveyance route of the sheet S from the main conveyance path 64 to the vertical conveyance path 72, the sheet S can be sent out from the main conveyance path 64 to the vertical conveyance path 72 and can be conveyed in the vertical direction by the vertical conveyance path 72.

When the sheet sensor 78 detects the rear end in the conveyance direction of the sheet S being conveyed in the vertical direction, the controller 160 stops the driving of the conveyance motor (not shown) to stop the rotation of the drive roller 98 (see FIG. 2 and FIG. 3). When the controller 160 stops the rotation of the drive roller 98, the pair of holding rollers 74G can pinch and hold the sheet S being conveyed in the vertical direction from the horizontal direction.

The controller 160 drives the rotary motor 122, 144, or 146 when a predetermined time elapses after the sheet sensor 78 detects the rear end in the conveyance direction of the sheet S which is being conveyed in the vertical direction. As the controller 160 drives the rotary motor 122,144, or 158, the pressing member 102 moves as described above to press the sheet S, and the stiffness sensor 104 detects the stiffness of the sheet S.

Based on the stiffness of the sheet S acquired from the stiffness sensor 104, the controller 160 sets various control parameters for performing image formation or the like on the sheet S. Examples of the various control parameters include the charge potential of the charging section, the transfer current to the secondary transfer roller 34, the fixing current of the fixing section 36, and the fixing temperature of the fixing section 36.

With the configuration of the stiffness measuring unit 68,124, or 146 according to the present embodiment, as described above, in a state where the sheet S being conveyed in the vertical direction is held by the holding roller pair 74G, the pressing member 102 presses the sheet S, and thus the stiffness of the sheet S can be detected. Therefore, the influence of the gravity acting on the sheet S can be suppressed in the detection of the stiffness of the sheet S.

Furthermore, as described above, the pressing mover 106,126, or 148 moves the pressing member 102 so as to suppress the displacement of the distal end portion of the pressing member 102 with respect to the sheet S when the pressing member 102 presses the sheet S. Therefore, the catching force (frictional force) of the pressing member 102 on the sheet S when the pressing member 102 presses the sheet S can be sufficiently suppressed.

Therefore, according to the image forming system 10 (image forming apparatus 12) of the present embodiment, it is possible to further increase the detection accuracy of the stiffness of the sheet by the stiffness measuring unit 68,124, or 146.

In addition, according to the configuration of the stiffness measuring unit 68 according to the present embodiment, as described above, the pressing mover 106 moves the pressing member 102 such that the distal end portion of the pressing member 102 draws a circular arc. Therefore, it is possible to more sufficiently suppress the catching force of the pressing member 102 with respect to the sheet S when the pressing member 102 presses the sheet S. In particular, when the distal end portion of the pressing member 102 draws a circular arc around the holding position of the holding roller pair 74G, the catching force of the pressing member 102 can be further suppressed.

Therefore, the image forming system 10 (image forming apparatus 12) according to the present embodiment can further increase the detection accuracy of the stiffness of the sheet by the stiffness measuring unit 68.

In addition, according to the configuration of the stiffness measuring unit 68 of the present embodiment, as described above, the pressing mover 106 includes the arm portion 110 which can swing around the swing shaft center passing through the holding position of the holding roller pair 74G or the vicinity thereof. The arm portion 110 is connected to the pressing member 102 via the stiffness sensor 104. Therefore, the pressing member 102 can be moved so that the distal end portion of the pressing member 102 draws a circular arc only by swinging the arm portion 110 around the swing axis. As a result, it is possible to more sufficiently suppress the catching force of the pressing member 102 with respect to the sheet S when the pressing member 102 presses the sheet S. In particular, when the distances from the axial centers of the swing shafts 108 to the distal end portions of the pressing members 102 are the same as the distances from the holding positions of the holding roller pair 74G to the pressing positions of the pressing members 102, the catching forces of the pressing members 102 can be further suppressed.

Therefore, the image forming system 10 (image forming apparatus 12) according to the present embodiment can further increase the detection accuracy of the stiffness of the sheet by the stiffness measuring unit 68.

According to the configuration of the stiffness measuring unit 68, 124, or 146 according to the present embodiment, as described above, the sectional shape of the distal end portion of the pressing member 102 along the vertical direction is a curved shape. Therefore, it is possible to more sufficiently suppress the catching force of the pressing member 102 with respect to the sheet S when the pressing member 102 presses the sheet S.

Therefore, according to the image forming system 10 (image forming apparatus 12) of the present embodiment, the detection accuracy of the stiffness of the sheet by the stiffness measuring unit 68, 124, or 146 can be further increased.

Furthermore, according to the configuration of the stiffness measuring unit 124 or 146 according to the present embodiment, as described above, the pressing mover 126 or 148 moves the pressing member 102 while maintaining the posture of the pressing member 102 when the pressing member 102 presses the sheet S. Therefore, it is possible to more sufficiently suppress the catching force of the pressing member 102 with respect to the sheet S when the pressing member 102 presses the sheet S. In particular, when the distal end portion of the pressing member 102 draws a circular arc around the holding position of the holding roller pair 74G, the catching force of the pressing member 102 can be further suppressed.

Therefore, according to the image forming system 10 (image forming apparatus 12) of the present embodiment, the detection accuracy of the stiffness of the sheet by the stiffness measuring unit 124 or 146 can be further increased.

Furthermore, with the configuration of the stiffness measuring unit 124 according to the present embodiment, as described above, the guide members 128 guide respective lateral end portions of the pressing member 102 so as to maintain the posture of the pressing member 102. Therefore, the pressing mover 126 can move the pressing member 102 while maintaining the posture of the pressing member 102 when the pressing member 102 presses the sheet S. As a result, it is possible to more sufficiently suppress the catching force of the pressing member 102 with respect to the sheet S when the pressing member 102 presses the sheet S.

Therefore, the image forming system 10 (image forming apparatus 12) according to the present embodiment can further increase the detection accuracy of the stiffness of the sheet by the stiffness measuring unit 124.

In addition, according to the configuration of the stiffness measuring unit 146 according to the present embodiment, as described above, parallel link mechanisms 150 include the translational movement links 156, respectively, which can be moved translationally in the horizontal direction and are connected to respective lateral end portions of the pressing member 102. Therefore, the pressing mover 148 can move the pressing member 102 while maintaining the posture of the pressing member 102 when the pressing member 102 presses the sheet S. As a result, it is possible to more sufficiently suppress the catching force of the pressing member 102 with respect to the sheet S when the pressing member 102 presses the sheet S.

Therefore, the image forming system 10 (image forming apparatus 12) according to the present embodiment can further increase the detection accuracy of the stiffness of the sheet by the stiffness measuring unit 146.

Although the present embodiment has been specifically described above, the present invention is not limited to the above-described specific embodiment. Various modifications and changes can be made to the specific example described in the above embodiment within the scope of the spirit of the present invention described in the claims.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming apparatus, comprising:
a holder that holds a recording medium being conveyed in a vertical direction;
a pressing member that presses a sheet at a lower side of a holding position of the holder;
a stiffness detector that detects, as stiffness of the recording medium, a reaction force from the recording medium pressed and bent by the pressing member; and
a pressing mover that moves the pressing member so as to suppress displacement of a distal end portion of the pressing member with respect to the recording medium when the pressing member presses the recording medium.

2. The image forming apparatus according to claim 1, wherein
the pressing mover moves the pressing member so that the distal end portion of the pressing member draws a circular arc when the pressing member presses the recording medium.

3. The image forming apparatus according to claim 2, wherein
a center of the circular arc is the holding position of the holder.

4. The image forming apparatus according to claim 1, wherein
the pressing mover includes an arm portion that is swingable around a horizontal swing axis passing through the holding position of the holder or vicinity thereof and that is connected to the pressing member.

5. The image forming apparatus according to claim 4, wherein
a distance from the horizontal swing axis of the arm portion to the distal end portion of the pressing member is the same as a distance from the holding position of the holder to a pressing position of the pressing member.

6. The image forming apparatus according to claim 4, wherein
the pressing mover further includes a cam mechanism for swinging the arm portion around the horizontal swing axis.

7. The image forming apparatus according to claim 1, wherein
the pressing mover moves the pressing member in a state where a posture of the pressing member when the pressing member presses the recording medium is maintained.

8. The image forming apparatus according to claim 7, wherein
the pressing mover moves the pressing member so that the distal end portion of the pressing member draws a circular arc when the pressing member presses the recording medium.

9. The image forming apparatus according to claim 7, wherein
the pressing mover includes a guide member that is disposed in or on a fixed portion and guides each lateral end portion of the pressing member so as to maintain the posture of the pressing member.

10. The image forming apparatus according to claim 9, wherein
the pressing mover includes a cam mechanism for moving the pressing member in a state where the lateral end portions of the pressing member are guided by the guide members, respectively.

11. The image forming apparatus according to claim 7, wherein:
the pressing mover includes parallel link mechanisms that are disposed on opposite lateral end portion sides of the holder and move the pressing member translationally in a horizontal direction, and
each of the parallel link mechanisms includes a translational movement link that is capable of translational movement in the horizontal direction and is coupled to the pressing member.

12. The image forming apparatus according to claim 11, wherein
the pressing member is disposed between a pair of the parallel link mechanisms.

13. The image forming apparatus according to claim 1, wherein
a sectional shape of the distal end portion of the pressing member along a vertical direction is a curved shape.
